(19) United States
(12) Patent Application Publication
(10) Pub. No.: US 2012/0296824 A1
(43) Pub. Date: Nov. 22, 2012

(54) SYSTEMS AND METHODS FOR CORRECTION OF INFORMATION IN CARD-NOT-PRESENT ACCOUNT-ON-FILE TRANSACTIONS

(76) Inventor: Sharon A. Rosano, New Canaan, CT (US)

(21) Appl. No.: 13/561,955

(22) Filed: Jul. 30, 2012

Related U.S. Application Data
(63) Continuation-in-part of application No. 11/966,549, filed on Dec. 28, 2007.

(51) Int. Cl. G06Q 20/40

(52) U.S. Cl. 705/44

(57) ABSTRACT

A method for processing a card-not-present account-on-file transaction over a computer device coupled to a database is provided. Further, a network-based system for processing a card-not-present account-on-file transaction having a first transaction date is provided. Additionally, a computer coupled to a database for processing a card-not-present account-on-file transaction, is provided. Further, a non-transitory computer readable storage medium storing computer-executable instructions thereon for processing a card-not-present account-on-file transaction, is provided. The transaction is made by a cardholder using payment card information stored by a merchant. The payment card information includes a payment card account identifier, an expiration date associated with the payment card account identifier, and a payment card number associated with the payment card account identifier.

### CROSS REFERENCE TO RELATED APPLICATIONS

This is a continuation in part of U.S. patent application Ser. No. 11/966,549, filed Dec. 28, 2007, which is hereby incorporated by reference in its entirety.

### BACKGROUND OF THE INVENTION

The field of the invention relates generally to systems and methods for processing payment transactions and, more particularly, to systems and methods for processing account-on-file transactions.

The payment card industry includes payment transactions wherein a payment cardholder makes a purchase, but the physical payment card is not present. These transactions are known as “card-not-present” (CNP) transactions. In such transactions, information regarding the payment card, including an account number and, in many instances, an expiration date for the payment card is transmitted from a merchant, along with an indicator that the transaction is a CNP transaction. An “account-on-file” transaction is a type of transaction in which the merchant stores information regarding the cardholder's payment card in a database, then retrieves the stored payment card information and includes it in at least one authorization request. One specific type of account-on-file transaction is a “recurring payment transaction”, which a merchant initiates on a recurring basis for a particular cardholder. In such recurring payment transactions, the merchant stores information regarding the cardholder's payment card in a database, then retrieves the stored payment card information and includes it in each recurring authorization request.

An example is a gym membership. Rather than mailing a monthly check for membership with a gym, a cardholder might choose to register a payment card, such as a credit card, a debit card, or a prepaid card, with the gym. Registering the payment card with the gym enables the gym to automatically charge the payment card for the monthly dues on a particular day each month. In some such systems, the merchant stores an account number, an expiration date, and/or other information associated with the payment card and/or cardholder. Given the convenience of this payment model for both merchants and cardholders, it finds use in many other scenarios where a cardholder is a member of a club or subscriber of products or services. Accordingly, multiple merchants may have stored payment card information for the same cardholder. Likewise, any given merchant may have stored payment card information for multiple cardholders.

A downside, however, is that information regarding a payment card is subject to change. For example a cardholder's payment card might expire, causing a new payment card to be issued with a new expiration date while the card number remains the same. In such instances, an authorization request containing the outdated expiration date is denied by the issuer of the payment card. As a result, the merchant who originally submitted the authorization request is prevented from successfully obtaining payment until the merchant acquires the updated expiration date for the payment card. Due to wide adoption of the account-on-file payment model by merchants and cardholders, it is understandably difficult for a cardholder to update each merchant with new payment card expiration dates. Likewise, it reduces the benefits of the account-on-file payment model to require a merchant to inquire with each cardholder for an updated payment card expiration date prior to submitting each payment authorization request. Accordingly, improvements are desired.

### BRIEF DESCRIPTION OF THE INVENTION

In one aspect, a method for processing a card-not-present account-on-file transaction over a computer device coupled to a database is provided. The transaction is made by a cardholder using payment card information stored by a merchant. The payment card information includes a payment card account identifier, an expiration date associated with the payment card account identifier, and a payment card number associated with the payment card account identifier. The method includes receiving a first authorization request message for the transaction, the first authorization request message received at the computer device from an acquirer associated with the merchant. The method further includes determining that the first authorization request message is associated with a card-not-present account-on-file transaction based on a first flag present in the first authorization request message. The method further includes querying the database to determine whether updated payment card information is stored therein, the updated payment card information including at least one of an updated expiration date associated with the payment card account identifier and an updated payment card number associated with the payment card account identifier. The method further includes transmitting a second authorization request message for the transaction to an issuer associated with the payment card account identifier, the second authorization request message including the updated payment card information.

In a further aspect, a network-based system for processing a card-not-present account-on-file transaction is provided. The transaction is made by a cardholder using payment card information stored by a merchant. The payment card information includes a payment card account identifier, an expiration date associated with the payment card account identifier, and a payment card number associated with the payment card account identifier. The system includes a payment network; a payment database for storing information for the payment card; and a payment network server, wherein the payment network communicatively couples said payment database with the payment network server. The payment network server is configured to receive a first authorization request message for the transaction, the first authorization request message received from an acquirer associated with the merchant. The payment network server is further configured to determine that the first authorization request message is associated with a card-not-present account-on-file transaction based on a first flag present in the first authorization request message. The payment network server is further configured to query the payment network database to determine whether updated payment card information is stored therein, the updated payment card information including at least one of an updated expiration date associated with the payment card account identifier and an updated payment card number associated with the payment card account identifier. The payment network server is further configured to transmit a second authorization request message for the transaction to an issuer associated with the payment card account identifier, the second authorization request message including the updated payment card information.

In another aspect, a computer coupled to a database for processing a card-not-present account-on-file transaction made by a cardholder using payment card information stored by a merchant, the payment card information including a payment card number. The computer is programmed to receive a first authorization request message for the transaction, the first authorization request message received from an acquirer associated with the merchant. The computer is further programmed to determine that the first authorization request message is associated with a card-not-present account-on-file transaction based on a first flag present in the first authorization request message. The computer is further programmed to query the database to determine whether updated payment card information is stored therein, the updated payment card information including at least one of an updated expiration date associated with the payment card account identifier and an updated payment card number associated with the payment card account identifier. The computer is further programmed to transmit a second authorization request message for the transaction to an issuer associated with the payment card account identifier, the second authorization request message including the updated payment card information.

In another aspect, a non-transitory computer readable storage medium storing computer-executable instructions thereon for processing a card-not-present account-on-file transaction is provided. The transaction is made by a cardholder using payment card information stored by a merchant, the payment card information including a payment card account identifier, an expiration date associated with the payment card account identifier, and a payment card number associated with the payment card account identifier. When executed by a computer coupled to a database, the computer-executable instructions cause the computer to receive a first authorization request message for the transaction, the first authorization request message received from an acquirer associated with the merchant. The computer-executable instruction further cause the computer to determine that the first authorization request message is associated with a card-not-present account-on-file transaction based on a first flag present in the first authorization request message. The computer-executable instruction further cause the computer to query the database to determine whether updated payment card information is stored therein, the updated payment card information including at least one of an updated expiration date associated with the payment card account identifier and an updated payment card number associated with the payment card account identifier. The computer-executable instruction further cause the computer to transmit a second authorization request message for the transaction to an issuer associated with the payment card account identifier, the second authorization request message including the updated payment card information.

### BRIEF DESCRIPTION OF THE DRAWINGS

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of a conventional billing update process.

FIG. 3 is a simplified block diagram of an exemplary embodiment of a server architecture of a system in accordance with an embodiment of the present invention.

FIG. 4 is an expanded block diagram of an exemplary embodiment of a server architecture of a system in accordance with one embodiment of the present invention.

FIG. 5 illustrates an exemplary configuration of a cardholder computer device operated by a cardholder.

FIG. 6 illustrates an exemplary configuration of a server computer device such as the server system shown in FIGS. 3 and 4.

FIG. 7 is a simplified flowchart illustrating an exemplary process utilized by the system shown in FIG. 4 for processing an account-on-file transaction.

FIG. 8 is a flowchart of an exemplary method that may be implemented in the system shown in FIG. 4 to process an account-on-file transaction

FIG. 9 is a flowchart of an exemplary method that may be implemented to provide updated payment card information.

FIG. 10 is a flowchart of an exemplary method that may be implemented in the system shown in FIG. 4 to process a payment transaction in which a payment card is present at a point of interaction.

FIG. 11 is a flowchart of an exemplary method that may be implemented to correct an outdated payment card expiration date used in a transaction.

### DETAILED DESCRIPTION OF THE INVENTION

As used herein, an acquiring bank, or acquirer, is typically a bank at which a merchant holds an account. Further, an issuing bank, or issuer, is typically a bank at which a customer, or cardholder, holds an account. The account may be debited or charged through the use of a debit card, a credit card, or another type of financial transaction card as described herein.

Financial transaction cards, or payment cards, may refer to credit cards, debit cards, and prepaid cards. These cards may all be used as a method of payment for performing a transaction, such as a recurring transaction. As described herein, the term “financial transaction card” or “payment card” includes cards such as credit cards, debit cards, and prepaid cards. Also included is any other device that may hold payment account information for use in recurring transactions, such as mobile phones, personal digital assistants (PDAs), and key fobs.

As used herein, a processor may include any programmable system including systems using microcontrollers, reduced instruction set circuits (RISC), application specific integrated circuits (ASICs), logic circuits, and any other circuit or processor capable of executing the functions described herein. The above examples are exemplary only, and thus are not intended to limit the definition and/or meaning of the term “processor” in any way.

Described in detail herein are exemplary embodiments of systems and methods that facilitate updating, in real time, payment card information stored by a merchant for use in account-on-file transactions in which a card is not presented to the merchant. The systems and methods facilitate, for example, transferring new payment card information electronically over a network to update payment card information stored by a merchant that is found to be stale due to a change in card status and/or the issuance of a new card to the cardholder by an issuing bank.

Also described herein are systems and methods facilitate, for example, transferring new payment card information electronically over a network to an acquirer for a particular merchant who is conducting card-not-present account-on-file transactions. That is, if a card-not-present account-on-file authorization request message from a merchant is denied by an issuer, certain systems and methods according to the present invention facilitate detecting why the authorization request was denied. If the denial pertains to outdated payment card information included in the authorization request message, for example, due to a change in payment card status and/or the issuance of a new payment card to the cardholder from the issuing bank, certain systems and methods according to the present invention facilitate sending updated payment card information to the acquirer, to then be communicated to the merchant. The merchant may then resubmit the transaction using the updated payment card information. In alternative embodiments, the payment network server generates and transmits a subsequent authorization request message to the issuer on behalf of the merchant, without the merchant or acquirer taking steps to initiate a subsequent transaction with the updated payment card information. The subsequent authorization request message generated and transmitted by the payment network server in such alternative embodiments includes the updated payment card information.

Also described in detail herein are systems and methods that facilitate, for example, receiving an authorization request for a transaction from a particular merchant who is conducting card-not-present account-on-file transactions, determining that an expiration date for a payment card associated with the transaction is outdated, and correcting the authorization request before transmitting the authorization request to an issuer associated with the payment card. That is, if a card-not-present account-on-file authorization request message from a merchant includes an expiration date for a payment card, and querying a database of payment card information pertaining to transactions where the payment card was presented to a merchant indicates that a later expiration date is associated with the payment card, certain systems and methods according to the present invention facilitate replacing the earlier expiration date in the authorization request message with the later expiration date stored in the database. Certain systems and methods according to the present invention facilitate sending the corrected authorization request message to the issuer associated with the payment card, thereby reducing the likelihood of a denial of the authorization request message by the issuer due to an outdated expiration date.

A technical effect of the systems and methods described herein include at least one of (a) receiving a first authorization request message for the transaction, the first authorization request message received at a computer device coupled to a database from an acquirer associated with the merchant; (b) determining that the first authorization request message is associated with a CARD-NOT-PRESENT ACCOUNT-ON-FILE transaction based on a first flag present in the first authorization request message; (c) querying the database to determine whether updated payment card information is stored therein, the updated payment card information including at least one of an updated expiration date associated with the payment card account identifier and an updated payment card number associated with the payment card account identifier; and (d) transmitting a second authorization request message for the transaction to an issuer associated with the payment card account identifier, the second authorization request message including the updated payment card information.

In one embodiment, computer-executable instructions are provided and are embodied on a non-transitory computer readable storage medium. The computer-executable instructions cause a computer executing the instructions to utilize a Structured Query Language (SQL) with a client user interface front-end for administration and a web interface for standard user inputs and reports. In an exemplary embodiment, the system is web-enabled and is run on a business entity intranet. In an alternative embodiment, the system is fully accessible by individuals having authorized access from outside a firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

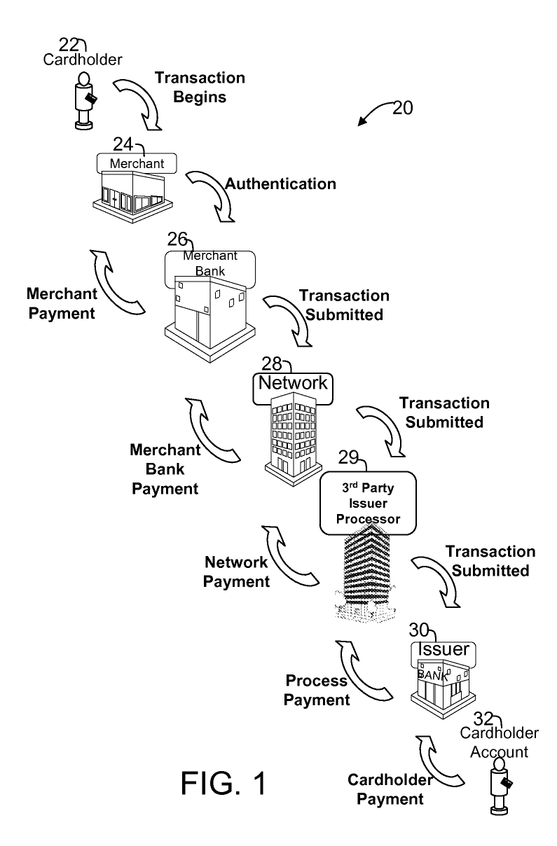

FIG. 1 is a schematic diagram illustrating an exemplary multi-party payment card system 20 for enabling ordinary payment-by-card transactions in which merchants and card issuers do not necessarily have a one-to-one relationship. The present invention relates to payment card system 20, such as a credit card payment system using the MasterCard® payment card system payment network 28. MasterCard® payment card system payment network 28 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, New York).

In payment card system 20, a financial institution such as an issuer 30 issues a payment account card, such as a credit card account or a debit card account, to a cardholder 22, who uses the payment account card to tender payment for a purchase from a merchant 24. To accept payment with the payment account card, merchant 24 must normally establish an account with a financial institution that is part of the financial payment system. This financial institution is usually called the “merchant bank” or the “acquiring bank” or “acquirer bank” or simply “acquirer”. When a cardholder 22 tenders payment for a purchase with a payment account card (also known as a financial transaction card), merchant 24 requests authorization from acquirer 26 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 26. Alternatively, acquirer 26 may authorize a third party to perform transaction processing on its behalf. In this case, the point-of-interaction terminal will be configured to communicate with the third party. Such a third party is usually called a “merchant processor” or an “acquiring processor.”

Using payment card system payment network 28, the computers of acquirer 26 or the merchant processor will communicate with the computers of issuer 30 to determine whether the cardholder's account is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, acquirer 26, and issuer 30. Settlement refers to the transfer of financial data or funds between the merchant's account, acquirer 26, and issuer 30 related to the transaction. Usually, transactions are captured and accumulated into a “batch,” which is settled as a group.

While the above discussion describes a type of transaction wherein the cardholder and the payment card are present at the point of interaction, card-not-present account-on-file transactions follow a different process. The process begins when a cardholder establishes an account-on-file relationship with a merchant. The cardholder provides payment card information to the merchant, thereby enabling the merchant to periodically charge the cardholder for a product or service by automatically charging the payment card on file. For example, the cardholder enters the payment card information into a web browser and submits the payment card information to the merchant. Thereafter, the merchant stores the payment card information in a database and/or server. The payment card information used by the merchant may include the cardholder's name as it appears on the payment card, a billing address, an account number or card number of the payment card, and/or an expiration date of the payment card.

At some point after the cardholder establishes the account-on-file relationship with the merchant, an issuing bank, or issuer, sends the cardholder a replacement payment card and, while the card number may stay the same, the expiration date is changed to a later date. In such a case, the new expiration date for the payment card is not on file with the merchant. Accordingly, when the merchant attempts to charge the cardholder using the payment card information stored by the merchant, the transaction is at risk of being denied due to the outdated expiration date.

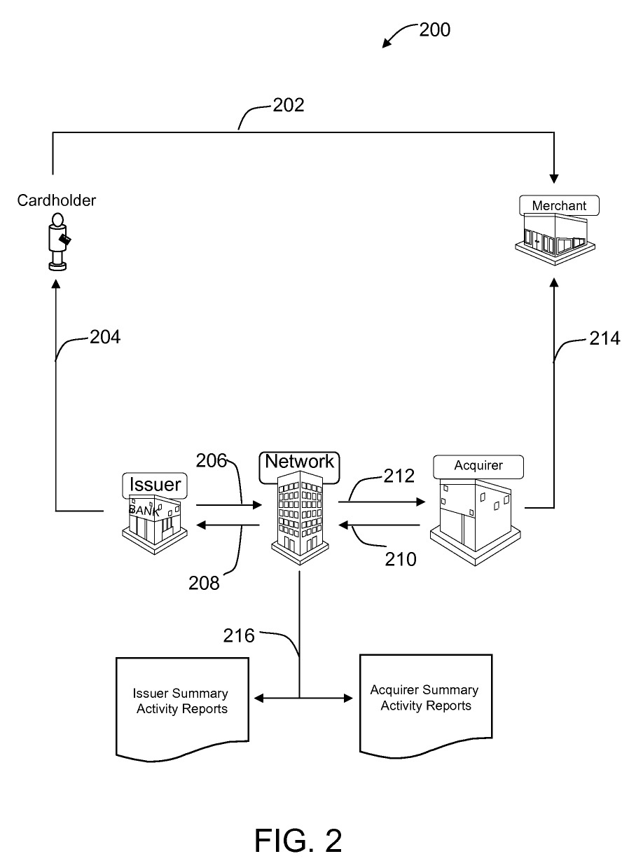

FIG. 2 is a flowchart 200 illustrating a conventional billing update process. The process begins when a cardholder establishes 202 an account-on-file relationship with a merchant. The cardholder provides payment card information to the merchant, thereby enabling the merchant to periodically charge the cardholder for a product or service by automatically charging the payment card on file. For example, the cardholder enters the payment card information into a web browser and submits the payment card information to the merchant. Thereafter, the merchant stores the payment card information in a database and/or server. The payment card information used by the merchant may include the cardholder's name as it appears on the payment card, a billing address, an account number or card number of the payment card, and/or an expiration date of the payment card.

At some point after the cardholder establishes 202 the account-on-file relationship with the merchant, an issuing bank, or issuer, sends 204 the cardholder a replacement payment card or may change one or more piece of payment card information, such as the expiration date. This may be due to a loss of the payment card by the cardholder or a reissue of a payment card due to security reasons and/or due to the passage of the payment card expiration date. In such a case, the new payment card information is not on file with the merchant. Accordingly, when the merchant attempts to charge the cardholder using the payment card information stored by the merchant, the transaction is at risk of being denied due to the outdated payment card information. To prevent a denial, the issuer may be enrolled in a payment card information update service that uses a MasterCard® interchange network (MasterCard International Incorporated, Purchase, N.Y.). The MasterCard® interchange network, which is an example of a payment network, is a proprietary communications standard promulgated by MasterCard International Incorporated® for the exchange of financial transaction data between financial institutions that are members of MasterCard International Incorporated®. The issuer sends 206 updated payment card information to the payment network, which stores 208 the updated payment card information.

Acquiring banks, or acquirers, may also enroll in such an update service in order to collect updated payment card information and to pass the updated payment card information to merchants. For example, an acquirer may periodically query 210 the payment network for information regarding payment cards. The payment network determines 212 whether there exists updated payment card information and, if so, sends the updated information to the acquirer. The acquirer then sends 214 the updated payment card information to the merchant and the merchant updates the outdated payment card information. Additionally, such a process includes a periodic report 216 of updated payment card information that is sent to acquirers and issuers.

Financial transaction cards, or payment cards, may refer to credit cards, debit cards, and prepaid cards. These cards may all be used as a method of payment for performing a transaction, such as a recurring transaction. As described herein, the term “financial transaction card” or “payment card” includes cards such as credit cards, debit cards, and prepaid cards. Also included is any other device that may hold payment account information for use in recurring transactions, such as mobile phones, personal digital assistants (PDAs), and key fobs. Also included are online virtual wallets. A “payment card account identifier” as used herein is, for example, an account number or any other number, character, symbol, item, or sequence thereof that identifies an account associated with a payment card.

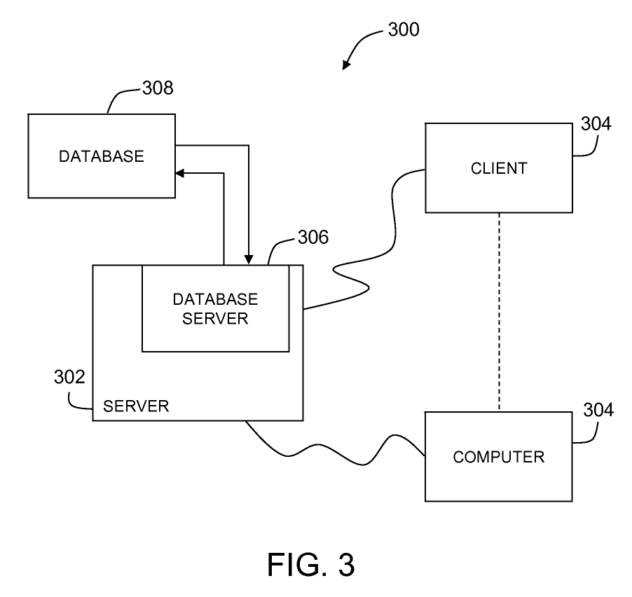

FIG. 3 is a simplified block diagram of an exemplary system 300 in accordance with one embodiment of the present invention. In the exemplary embodiment, system 300 includes a server system 302 and a plurality of client subsystems, also referred to as client systems 304, connected to server system 302. In one embodiment, client systems 304 are computers including a web browser, such that server system 302 is accessible to client systems 304 using the Internet. Client systems 304 are interconnected to the Internet through many interfaces including a network, such as a local area network (LAN) and/or a wide area network (WAN), dial-in connections, cable modems, wireless-connections, and special high-speed ISDN lines. Client systems 304 may be any device capable of interconnecting to the Internet including a web-based phone, personal digital assistant (PDA), or other web-connectable equipment. A database server 306 is connected to a database 308 containing information on a variety of matters, as described below in greater detail. In one embodiment, database 308 is stored on server system 302 and may be accessed by potential users at one of client systems 304 by logging onto server system 302 through one of client systems 304. In any alternative embodiment, database 308 is stored remotely from server system 302 and may be non-centralized.

As discussed below, payment card information including account numbers, payment card numbers, expiration dates, and account statuses, such as whether the account is open or closed, is stored within database 308. Further, data relating to the cardholder of a payment card may also be stored within database 308. Such cardholder data may include, for example, cardholder name and cardholder billing address.

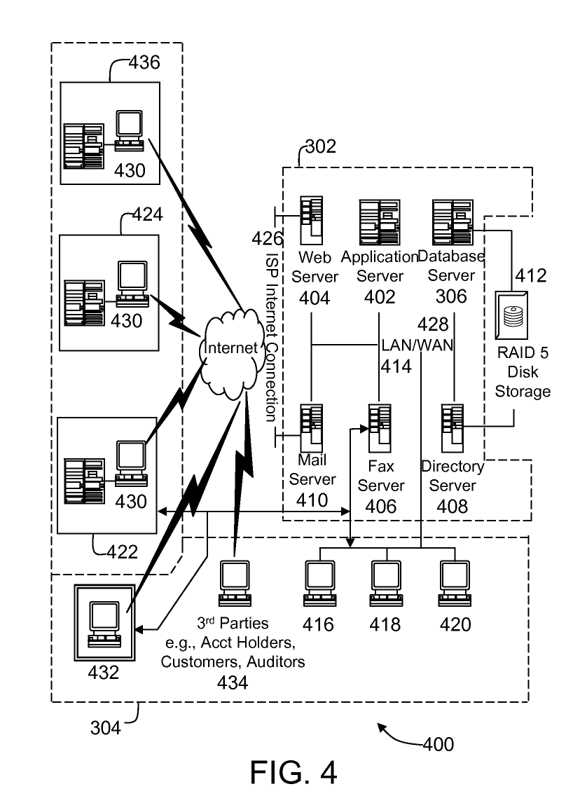

FIG. 4 is an expanded block diagram of an exemplary embodiment of a server architecture of a system 400 in accordance with one embodiment of the present invention. Components in system 400, identical to components of system 300 (shown in FIG. 3), are identified in FIG. 4 using the same reference numerals used in FIG. 3. System 400 includes server system 302 and client systems 304. Server system 302 further includes database server 306, an application server 402, a web server 404, a fax server 406, a directory server 408, and a mail server 410. A disk storage unit 412 is coupled to database server 306 and directory server 408. Servers 306, 402, 404, 406, 408, and 410 are coupled in a local area network (LAN) 414. In addition, a system administrator's workstation 416, a user workstation 418, and a supervisor's workstation 420 are coupled to LAN 414. Alternatively, workstations 416, 418, and 420 are coupled to LAN 414 using an Internet link or are connected through an Intranet.

Each workstation, 416, 418, and 420, is a personal computer having a web browser. Although the functions performed at the workstations typically are illustrated as being performed at respective workstations 416, 418, and 420, such functions can be performed at one of many personal computers coupled to LAN 414. Workstations 416, 418, and 420 are illustrated as being associated with separate functions only to facilitate an understanding of the different types of functions that can be performed by individuals having access to LAN 414.

Server system 302 is configured to be communicatively coupled to various entities, including acquirers 422 and issuers 424, and to third parties, e.g., auditors, 434 using an Internet connection 426. Server system 302 may also be communicatively coupled with a merchant 436. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 428, local area network 414 could be used in place of WAN 428.

In the exemplary embodiment, any authorized individual or entity having a workstation 430 may access system 400. At least one of the client systems includes a manager workstation 432 located at a remote location. Workstations 430 and 432 include personal computers having a web browser. Also, workstations 430 and 432 are configured to communicate with server system 302. Furthermore, fax server 406 communicates with remotely located client systems, including a client system 432, using a telephone link. Fax server 406 is configured to communicate with other client systems 416, 418, and 420 as well.

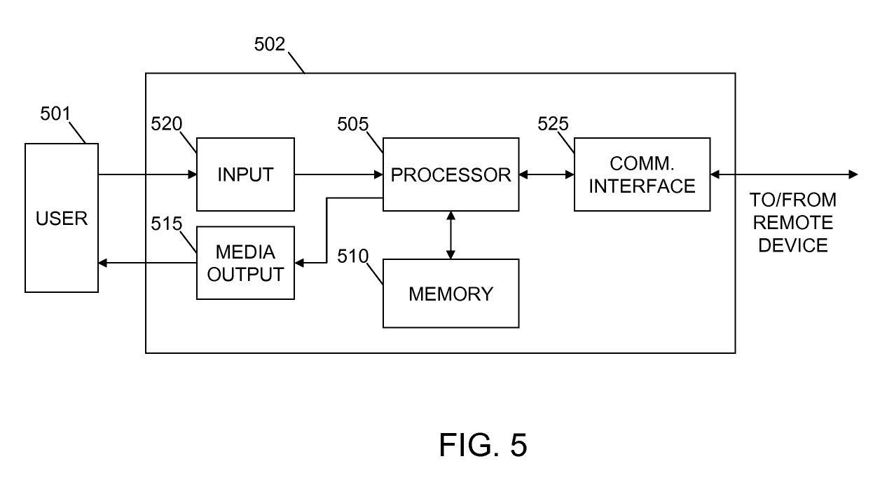

FIG. 5 illustrates an exemplary configuration of a cardholder computer device 502 operated by a cardholder 501. Cardholder computer device 502 may include, but is not limited to, client systems 304, 416, 418, and 420, workstation 430, and manager workstation 432 (shown in FIG. 4).

Cardholder computer device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer readable media.

Cardholder computer device 502 also includes at least one media output component 515 for presenting information to cardholder 501. Media output component 515 is any component capable of conveying information to cardholder 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer device 502 includes an input device 520 for receiving input from cardholder 501. Input device 520 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 515 and input device 520.

Cardholder computer device 502 may also include a communication interface 525, which is communicatively couplable to a remote device such as server system 302 or a web server operated by a merchant. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to cardholder 501 via media output component 515 and, optionally, receiving and processing input from input device 520. A user interface may include, among other possibilities, a web browser and client application. Web browsers enable cardholders, such as cardholder 501, to display and interact with media and other information typically embedded on a web page or a website from server system 302 or a web server associated with a merchant. A client application allows cardholder 501 to interact with a server application from server system 302 or a web server associated with a merchant.

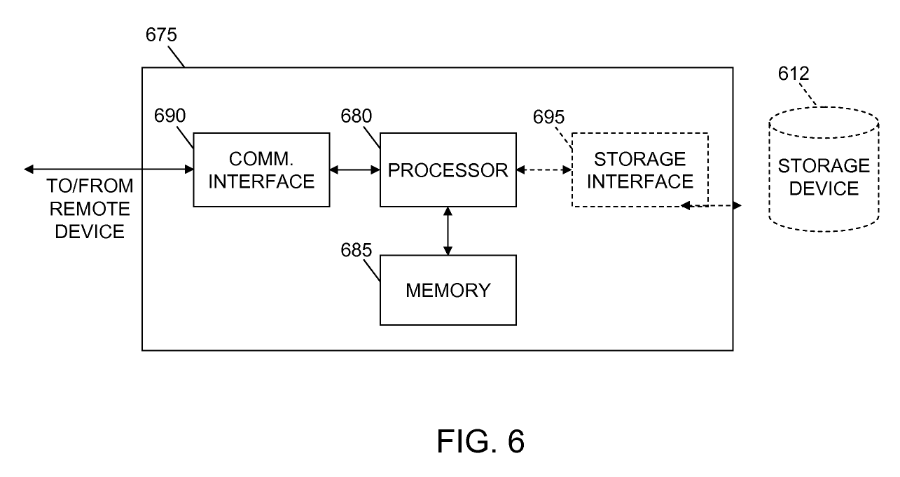

FIG. 6 illustrates an exemplary configuration of a server computer device 675 such as server system 302 (shown in FIGS. 3 and 4). Server computer device 675 may include, but is not limited to, database server 306, application server 402, web server 404, fax server 406, directory server 408, and mail server 410.

Server computer device 675 includes a processor 680 for executing instructions. Instructions may be stored in a memory area 685, for example. Processor 680 may include one or more processing units (e.g., in a multi-core configuration).

Processor 680 is operatively coupled to a communication interface 690 such that server computer device 675 is capable of communicating with a remote device such as cardholder computer device 502 or another server computer device 675. For example, communication interface 690 may receive requests from client systems 304 via the Internet, as illustrated in FIGS. 3 and 4.

Processor 680 may also be operatively coupled to a storage device 412. Storage device 412 is any computer-operated hardware suitable for storing and/or retrieving data. In some embodiments, storage device 412 is integrated in server computer device 675. For example, server computer device 675 may include one or more hard disk drives as storage device 412. In other embodiments, storage device 412 is external to server computer device 675 and may be accessed by a plurality of server computer devices 675. For example, storage device 412 may include multiple storage units such as hard disks or solid state disks in a redundant array of inexpensive disks (RAID) configuration. Storage device 412 may include a storage area network (SAN) and/or a network attached storage (NAS) system.

In some embodiments, processor 680 is operatively coupled to storage device 412 via a storage interface 695. Storage interface 695 is any component capable of providing processor 680 with access to storage device 412. Storage interface 695 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 680 with access to storage device 412.

Memory areas 410 and 685 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

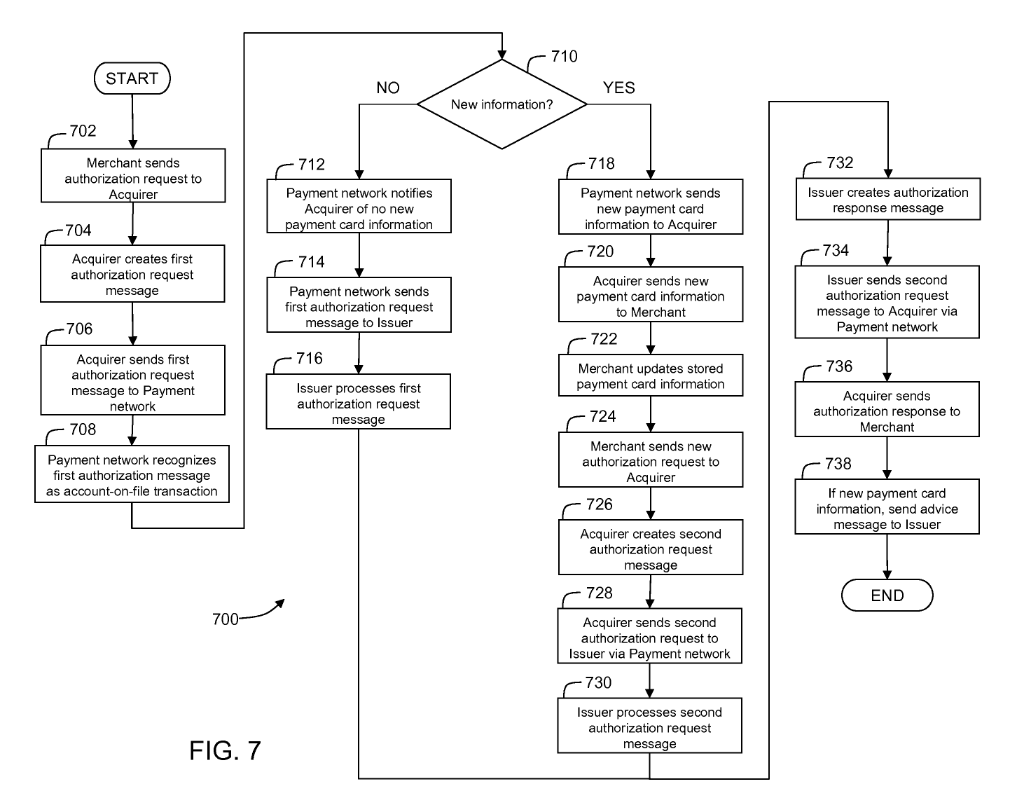

FIG. 7 is a simplified flowchart 700 illustrating an exemplary process utilized by system 400 shown in FIG. 4 for processing an account-on-file transaction. System 400 is sometimes referred to as the account-on-file transaction system, which may be utilized for processing payments using payment card information stored by a merchant. In the exemplary embodiment, system 400 may be utilized by an issuer that issues a payment card, a consumer or cardholder who uses the payment card to tender payment for a recurring purchase from a merchant, a merchant that sells a product or service, an acquirer, and a credit card network or payment network for processing the payment transaction. System 400 may also be utilized by the payment card network or payment network to send updated payment card information to a merchant for updating stale payment card information stored by the merchant.

In the exemplary embodiment, system 400 facilitates updating stale payment card information. A technical effect of the systems and methods described herein is achieved by storing, by a cardholder, payment card information at a merchant. For example, the cardholder may enter the payment card information using a web browser or may enter the payment card information into a paper form while at the merchant. The payment card information may include information such as an account or card number, an expiration date for the payment card, and/or an account status such as open or closed. The merchant then uses the stored payment card information for periodic, or recurring, transactions. In so doing, the merchant sends 702 an authorization request to acquirer 422 (shown in FIG. 4). Acquirer 422 receives the authorization request and creates 704 a first authorization request message based on information included in the authorization request, such as an identifier, or flag, signifying that the transaction is an account-on-file transaction in which the card is not presented to the merchant. The first authorization request message also includes the transaction amount, an issuer identifier, an acquirer identifier, an account number associated with the payment card, an expiration date associated with the payment card, and/or an account status of the account associated with the payment card. The first authorization request message is formatted to enable the message to be communicated over a payment network, such as the MasterCard® interchange network. Acquirer 422 then sends 706 the first authorization request message to the payment network, or server system 302 (shown in FIG. 4).

Upon receiving the first authorization request message, server system 302, by using the flag, identifies 708 the transaction as a card-not-present account-on-file transaction. In one embodiment, the payment network also verifies that acquirer 422 and issuer 424 (shown in FIG. 4) are members of the payment network, by checking the issuer identifier and acquirer identifier included in the first authorization request message. In the exemplary embodiment, server system 302 then determines 710 whether the payment card information included in the first authorization request message is stale. Server system 302 queries database 308 (shown in FIG. 3) to determine whether database 308 includes updated payment card information. In one embodiment, database 308 includes payment card information for those payment cards having new information for a predetermined period. In an alternative embodiment, database 308 includes payment card information for all payment cards, and server system 302 matches the payment card information included in the first authorization request message with the payment card information stored in database 308.

In the exemplary embodiment, if database 308 does not include updated payment card information, server system 302 sends 712 a notification message to acquirer 422 showing that database 308 does not include updated information. Server system 302 also sends 714 the first authorization request message to issuer 424. Issuer 424 processes 716 the first authorization request message to generate either an authorization code, signifying that the transaction is authorized, or a denial code, signifying that the transaction is denied. For example, issuer 424 may deny the transaction if authorizing the transaction would cause the account associated with the payment card to exceed a predetermined credit limit. As another example, issuer 424 may deny the transaction if authorizing the transaction would cause the account associated with the payment card to be overdrawn, beyond a current account balance. After issuer 424 processes 716 the transaction, issuer 424 creates 732 an authorization response message that includes either an authorization code or a denial code for the transaction. The authorization response message is formatted to enable the message to be communicated over the payment network. Issuer 424 sends 734 the authorization response message to acquirer 422, via server system 302. Acquirer 422 then sends 736 an authorization code or denial code to the merchant.

In the exemplary embodiment, if database 308 does include updated payment card information, server system 302 sends 718 the new payment card information to acquirer 422, which then sends 720 the new payment card information to the merchant. The merchant updates 722 the payment card information stored by the merchant, using the new payment card information. For example, if the updated account number stored by database 308 differs from the account number stored by the merchant, the merchant will update its stored account number to match the account number stored by database 308. As another example, if the account status stored by database 308 signifies that the account has been closed, the merchant will update its stored payment card information accordingly. In one embodiment, the account or payments associated with that payment card may be marked in order to prompt the merchant to contact the cardholder regarding the payments. After the payment card information has been updated, the merchant sends 724 a second authorization request to acquirer 422. Acquirer 422 then creates 726 a second authorization request message and sends 728 the second authorization request message to issuer 424 via the payment network. The second authorization request message includes substantially similar elements as the first authorization request message, as described above. In one embodiment, the second authorization request message may also include a flag signifying that the payment card information has already been updated by the merchant, enabling server system 302 to bypass querying database 308 for new payment card information.

Issuer 424 processes 730 the second authorization request message and creates 732 an authorization response message, as described above. Issuer 424 then sends 734 the authorization response message to acquirer 422 via the payment network. Acquirer 422 then sends 736 an authorization code or denial code to the merchant. If the second authorization request message includes a flag signifying that the payment card information was updated by the merchant, server system 302 sends 738 an advice message to issuer 424. The advice message includes that the first authorization request message was not approved and includes a reason, i.e., that the merchant attempted to use stale payment card information.

The systems and methods described above enable real time payment card information updates to be made by a merchant during a transaction, without delays involved with requiring the merchant to contact the cardholder for the updated information. The merchant is instantly aware that the payment card information has changed, which reduces the need to delay the transaction until the cardholder or issuing bank is contacted. In addition, the issuing bank, the acquiring bank, and the merchant benefit from lower rates of transaction denials due to stale information stored by the merchant. This lowers the cost of operations for the issuing bank, acquiring bank, and/or merchant by alleviating the need to contact the cardholder, and also results in greater satisfaction for the cardholder in that the payment card information only needs to be entered at the initial setup of the account-on-file payment relationship.

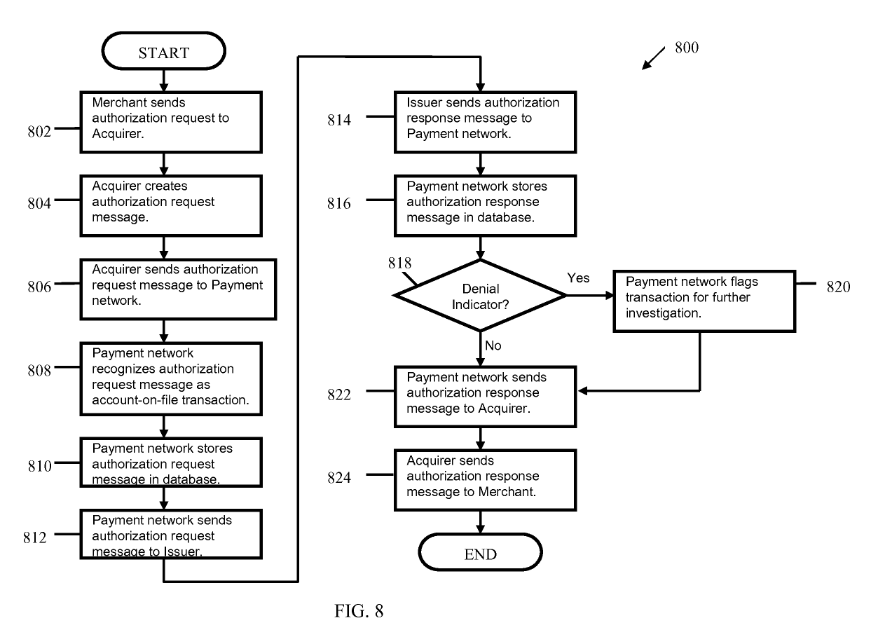

FIG. 8 is a flowchart of an exemplary method 800 implemented by system 400 (shown in FIG. 4) for processing an account-on-file transaction. During operation, in some implementations, a merchant transmits 802 an authorization request to an acquirer 422. In the exemplary implementation, payment card information is stored by a merchant after a cardholder initiates an original transaction using a payment card associated with the payment card information. Later, the merchant uses the stored payment card info to initiate subsequent transactions for the cardholder. These subsequent transactions are sometimes referred to as recurring transactions. When the authorization request is received by the acquirer 422, a corresponding authorization request message is created 804. The authorization request message is then transmitted 806 to a payment network server system 302.

When the payment network server system 302 receives the authorization request message, transaction data is analyzed. Specifically, in the exemplary implementation, the payment network server system 302 may recognize 808 the authorization request message as a card-not-present account-on-file transaction via a flag. A flag is a datum, typically evaluated as “true” or “false”, which may be used to characterize data. In various other implementations, a card-not-present account-on-file transaction may be recognized by any other distinct characteristic of the authorization request message or identifier that may be included within the authorization request message.

If the payment network server system 302 recognizes the authorization request message as a card-not-present account-on-file transaction, the payment network server system 302 stores 810 the authorization request message in database 308. After the authorization request message is stored in the database 308, the payment network server system 302 transmits 812 the authorization request message to an issuer 424 associated with the payment card.

The issuer 424 receives the authorization request message and, subsequently, determines whether to approve the transaction based on, for example, whether the cardholder's account is open or has been closed, whether the payment card number is correct, and/or whether the expiration date associated with the payment card is correct. The issuer 424 then sends 814 an authorization response message back to the payment network server system 302. The authorization response message includes an indication of whether the transaction was approved or denied. For example, in the exemplary implementation, if the transaction is denied, the issuer transmits 814 an authorization response message to the payment network server system 302 that includes a denial indicator. The denial indicator may indicate why the transaction is denied. In the exemplary embodiment, the denial indicator may include a code of 14, indicating an invalid payment card number. Also, in the exemplary embodiment, the denial indicator may include a code of 54, indicating an expired payment card or incorrect expiration date. Further, in the exemplary embodiment, the denial indicator may include a code of 5, representing a miscellaneous denial.

At step 816, the payment network server system 302 receives, from the issuer 424, the authorization response message in response to the authorization request message. In the exemplary implementation, the payment network server system 302 stores 816 the authorization response message in database 308. If the payment network server system 302 identifies 818 a denial indicator in the authorization response message, the payment network sever system 302 includes a flag 820 in the corresponding stored transaction data, thereby flagging it for further investigation. Subsequently, the payment network server system 302 transmits 822 the authorization response message to the acquirer 422. In transmitting the authorization response message to acquirer 422, the payment network server system 302 may include a flag in the response message indicating that the transaction has been flagged for further investigation. The acquirer 422 then transmits 824 the authorization response message to the merchant.

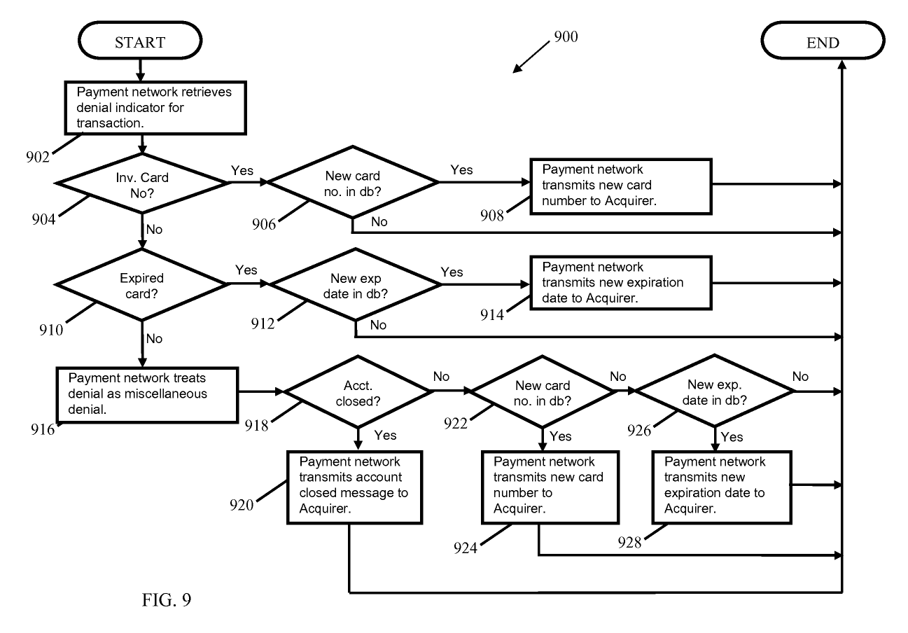

FIG. 9 is a flowchart of an exemplary method 900 that may be implemented using system 400 (shown in FIG. 4) to provide a merchant with updated payment card information. In the exemplary implementation, updated payment card information may be provided to a merchant when a card-not-present account-on-file transaction is denied. During operation, payment network server system 302 retrieves 902 from database 308 data regarding transactions that have been flagged for further investigation, pursuant to step 920 (shown in FIG. 8). As explained below, the payment network server system 302 identifies the reason for the issuer's 424 denial of the transaction by analyzing the retrieved data and, when available, transmits updated payment card information to the merchant.

In the exemplary method 900, the payment network server system 302 first determines 904 if the denial indicator corresponds with an invalid payment card number. In the exemplary embodiment, the denial indicator includes a code of 54 (or any other identifier associated with an invalid payment card number) to represent that the issuer 424 denied the transaction due to an invalid payment card number. When the denial indicator corresponds with an invalid payment card number, the payment network server system 302 then determines 906 if a new payment card number associated with the cardholder's account is available in the database 308. In the exemplary implementation, a new payment card number may be available when the payment card number stored in the database 308 differs from the payment card number associated with the denial indicator.

If a new payment card number is available, the payment network server system 302 transmits 908 the new payment card number to the acquirer 422. In some embodiments, the payment network server system 302 does not transmit updated payment card information, such as a new payment card number, to an acquirer 422 until the acquirer requests updated payment card information. In other embodiments, the payment network server system 302 proactively transmits the updated payment card information to the acquirer 422 without a request from the acquirer 422 for such information. In some embodiments, transmitting the new payment card number to the acquirer 422, includes additionally transmitting identifying information pertaining to the transaction and/or the merchant, such as a transaction number, a transaction date, a transaction time, a purchase amount, a merchant name or number, and/or the original payment card information submitted in the authorization request message.

In some embodiments, the information is pushed to the acquirer electronically, such as through email, fax, short message service (SMS), telephonic voice message, or other electronic messaging means. In other embodiments, the information is sent to the acquirer via mail or a courier service. In yet other embodiments, the information is presented to the acquirer 422 by payment network server system 302 upon the acquirer 422 successfully authenticating to server system 302. For example, acquirer 422 authenticates to payment network server system 302 through a website operated by web server 404. Upon successful authentication, web server 404 presents the above-discussed transaction-identifying information, in addition to the updated payment card information, on a webpage. In such embodiments, the acquirer computer 422 authenticates to the payment network server system 302 using, for example, a username and password.

When the denial indicator does not correspond with an invalid payment card number, the payment network server system 302 then determines 910 if the denial indicator corresponds with an expired payment card or incorrect expiration date. In the exemplary embodiment, the denial indicator corresponds with an expired payment card or incorrect expiration date when the denial indicator includes a code of 54. When the denial indicator corresponds with an expired payment card or incorrect expiration date, the payment network server system 302 then determines 912 if a new payment card expiration date is available in the database 308. When a new payment card expiration date is available in database 308, the payment network server system 302 transmits 914 the new payment card expiration date to the acquirer as discussed above, with reference to step 908.

When the denial indicator does not correspond with either of an invalid payment card number and an incorrect expiration date, the payment network server system 302 determines 916 that the denial indicator is a miscellaneous denial. That is, treating the denial indicator as being associated with a miscellaneous denial is a fallback position that the payment network server system 302 will reach if the denial indicator is not associated with an invalid payment card number or an expired payment card number. However, in certain embodiments, the payment network server system 302 will immediately reach this fallback position if the denial indicator includes a code associated with a miscellaneous denial. Again, in the exemplary embodiment, a code of 54 in a denial indicator indicates a miscellaneous denial.

In the exemplary implementation, a miscellaneous denial may be effected by various conditions, such as a closed account, an invalid payment card number, or an expired payment card or incorrect expiration date. Accordingly, the payment network first determines 918 if the account associated with the payment card is closed by retrieving account status information from database 308. When the account associated with the payment card is closed, according to database 308, the payment network transmits 920 a message to the acquirer 422 indicating at least that the payment card account is closed. The transmission of this information is carried out as discussed above, with reference to step 908.

If, according to the database 308, the account associated with the payment card is open, the payment network server system 302 then determines 922 if a new payment card number is stored in the database 308. If a new payment card number is stored in the database 308, the payment network server system 302 transmits 924 the new payment card number to the acquirer 422. The transmission of this information is carried out as discussed above, with reference to step 908.

When the account associated with the payment card is open and a new payment card number is not available in the payment network database 308, the payment network server system 302 then determines 926 if a new payment card expiration date is stored in the database 308. If a new payment card expiration date is stored in the database 308, the payment network server system 302 transmits 928 the new payment card expiration date to the acquirer 422. The transmission of this information is carried out as discussed above, with reference to step 908.

Upon receiving updated payment card information associated with a transaction authorization request that was denied, the acquirer 422 provides the updated information to the merchant to enable to merchant to update its records. The acquirer 422 may present the updated information to the merchant proactively, or upon request by the merchant. The merchant may then resubmit the transaction using the updated payment card information. In alternative embodiments, the payment network server generates and transmits a subsequent authorization request message to the issuer on behalf of the merchant, without the merchant or acquirer taking steps to initiate a subsequent transaction with the updated payment card information. The subsequent authorization request message generated and transmitted by the payment network server in such alternative embodiments includes the updated payment card information.

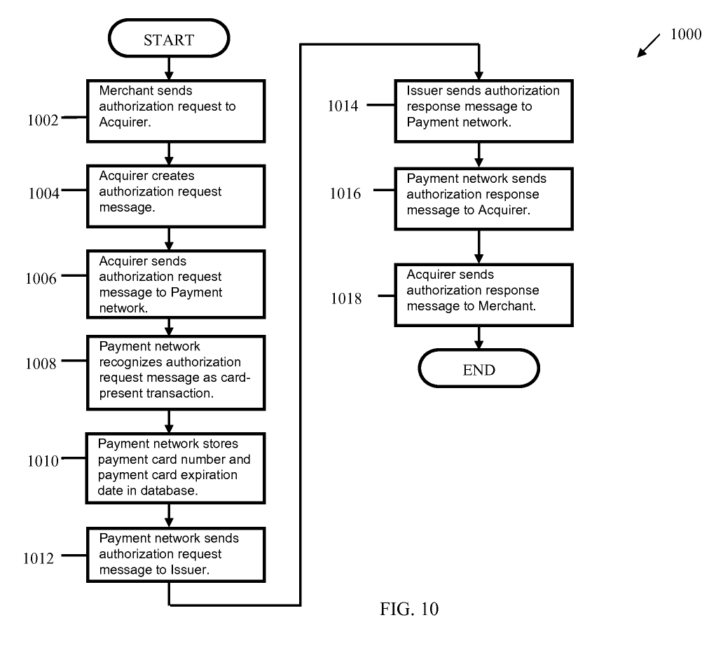

FIG. 10 is a flowchart of an exemplary method 1000 utilized by system 400 (shown in FIG. 4) for processing a payment transaction in which a payment card is present at the point of interaction of a merchant 436. During operation, in some implementations, a merchant 436 transmits 1002 an authorization request to an acquirer 422. In the exemplary implementation, authorization request data is generated when a transaction is initiated by a cardholder using a payment card that is present at the point of interaction of merchant 436. When the authorization request is received by the acquirer 422, a corresponding authorization request message is created 1004. The authorization request message includes, among other data, the payment card number and the expiration date of the payment card. In alternative embodiments, the authorization request message includes additional data, for example, a merchant identifier, an acquirer identifier, a transaction date, and a transaction amount. The authorization request message is then transmitted 1006 to a payment network server system 302.

When the payment network server system 302 receives the authorization request message, transaction data is analyzed. Specifically, in the exemplary implementation, the payment network server system 302 may recognize 1008 the authorization request message as a card-present transaction via a flag. A flag is a datum, typically evaluated as “true” or “false”, which may be used to characterize data. In various other implementations, a card-present transaction may be recognized by any other distinct characteristic of the authorization request message, including the absence of a flag indicating that the transaction is other than a card-present transaction.

Upon recognizing the authorization request message as pertaining to a card-present transaction, payment network server system 302 stores 1010 data from the authorization request message in database 308. In the exemplary embodiment, payment network server system 302 stores in database 308 at least the payment card number and the expiration date associated with the payment card number. In other embodiments, payment network server system 302 stores additional information, for example, the merchant identifier, the acquirer identifier, and the transaction date. After data from the authorization request message is stored in the database 308, the payment network server system 302 transmits 1012 the authorization request message to an issuer 424 associated with the payment card.

The issuer 424 receives the authorization request message and, subsequently, determines whether to approve the transaction based on, for example, whether the cardholder's account is open or has been closed, whether the cardholder's account has sufficient funds or credit, whether the payment card number is correct, and/or whether the expiration date associated with the payment card is correct. The issuer 424 then sends 1014 an authorization response message back to the payment network server system 302. The authorization response message includes an indication of whether the transaction was approved or denied. For example, in the exemplary implementation, if the transaction is denied, the issuer transmits 1014 an authorization response message to the payment network server system 302 that includes a denial indicator. The denial indicator may indicate why the transaction is denied. In the exemplary embodiment, the denial indicator may include a code of 14, indicating an invalid payment card number. Also, in the exemplary embodiment, the denial indicator may include a code of 54, indicating an outdated or incorrect expiration date. Further, in the exemplary embodiment, the denial indicator may include a code of 5, representing a miscellaneous denial. In other embodiments, other codes are used to represent reasons for denial of the authorization request.

At step 1014, the payment network server system 302 receives, from the issuer 424, the authorization response message in response to the authorization request message. In some embodiments, payment network server system 302 will delete the data stored in database 308 from step 1010 if the authorization response includes a denial indicator indicating that the expiration date is outdated or incorrect. This might occur if the cardholder has been issued a newer payment card and the cardholder has accidentally attempted to use the older payment card in a transaction after the expiration date on the older card has passed. At step 1016, the payment network server system 302 transmits the authorization response message to the acquirer 422. The acquirer 422 then transmits 1018 the authorization response message to the merchant 436.

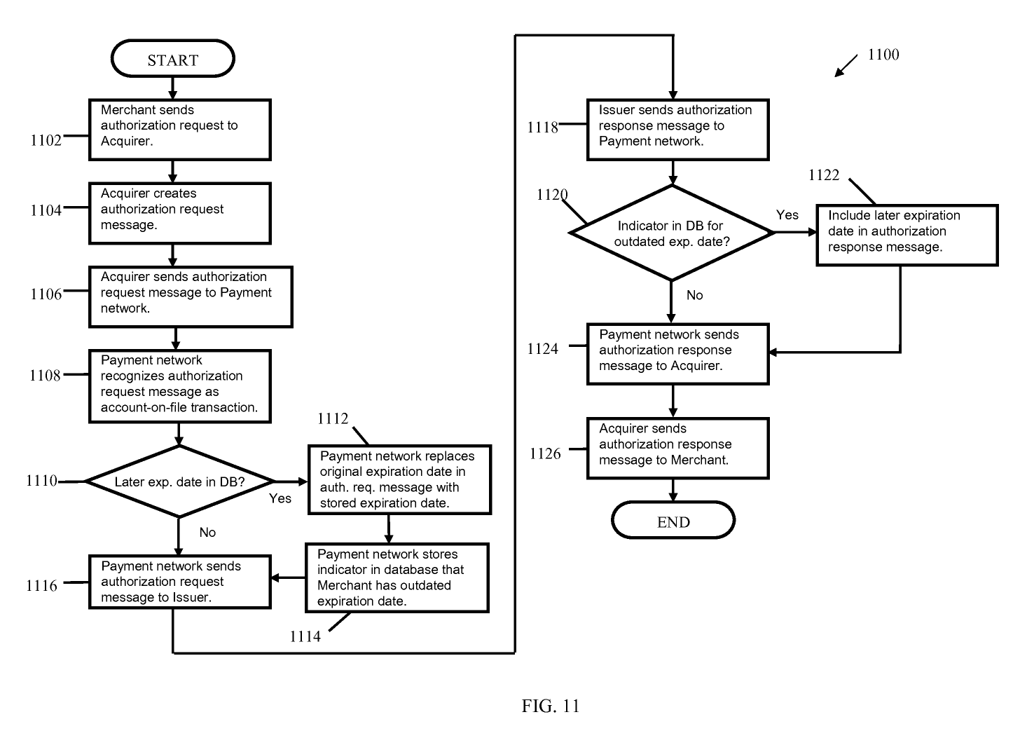

FIG. 11 is a flowchart of an exemplary method 1100 that may be implemented using system 400 (shown in FIG. 4) to correct an outdated payment card expiration date used in a transaction. In the exemplary implementation, payment card information is stored by a merchant after a cardholder initiates an original transaction using a payment card associated with the payment card information. Later, the merchant uses the stored payment card information to initiate subsequent transactions for the cardholder. These subsequent transactions are sometimes referred to as card-not-present account-on-file transactions. If a merchant 436 is initiating a card-not-present account-on-file transaction on behalf of a cardholder using a stored payment card expiration date that is outdated, the method 1100 may correct the expiration date prior to an authorization request message for the transaction reaching the cardholder's issuer 424.

At step 1102, merchant 436 sends an authorization request for a card-not-present account-on-file transaction to an acquirer 422. The merchant and acquirer of method 1100 may be different than the merchant and acquirer of method 1000, shown in FIG. 10. However, for simplicity, the merchants and acquirers of both methods, 1000 (FIGS. 10) and 1100 (FIG. 11), are referred to with the same labels, 422 and 436, in system 400 (FIG. 4). The merchant 436 has included a stored payment card number and a stored expiration date for the payment card in the authorization request. When the authorization request is received by the acquirer 422, acquirer 422 creates 1104 a corresponding authorization request message. The authorization request message includes, among other data, the payment card number and the expiration date of the payment card. In alternative embodiments, the authorization request message includes additional data, for example, a merchant identifier, an acquirer identifier, a transaction date, and a transaction amount. At step 1106, acquirer 422 transmits the authorization request message to payment network server system 302.

When payment network server system 302 receives the authorization request message, payment network server system 302 analyzes the content of the authorization request message. Specifically, in the exemplary implementation, payment network server system 302 recognizes 1108 the authorization request message as a card-not-present account-on-file transaction due to a flag. As explained above, a flag is a datum, typically evaluated as “true” or “false”, which may be used to characterize data. In various other implementations, a card-not-present account-on-file transaction may be recognized by any other distinct characteristic of the authorization request message, including the absence of a flag indicating that the transaction is other than a card-not-present account-on-file transaction.

Upon recognizing the authorization request message as pertaining to a card-not-present account-on-file transaction, payment network server system 302 queries database 308 and determines 1110 whether the expiration date in the authorization request message is earlier than an expiration date stored in database 308 for the payment card. For example, the database 308 might contain a later expiration date for the payment card upon the performance of step 1010 in method 1000 (FIG. 10). In some embodiments, payment network server system 302 first determines whether the date of the transaction associated with the authorization request message is equal to or later than the payment card expiration date stated in the authorization request message, and proceeds with querying database 308 for a later payment card expiration date only if the date of the transaction is equal to or later than the payment card expiration date stated in the authorization request message.

If the payment card expiration date in the authorization request message is earlier than an expiration date stored in database 308 for the same payment card, then at step 1112, payment network server 302 replaces the original expiration date in the authorization request message with the later expiration date from the database 308. Further, at step 1114, payment network server 302 stores 1114 an indicator in database 308 indicating that merchant 436 has an outdated expiration date for the payment card. In some embodiments, payment network server 302 performs steps 1112 and 1114 only if the later expiration date stored in database 308 is equal to or later than the date of the transaction.

At step 1116, payment network server 302 transmits the authorization request message to issuer 424. The issuer 424 receives the authorization request message and, subsequently, determines whether to approve the transaction based on, for example, whether the cardholder's account is open or has been closed, whether the cardholder's account has sufficient funds or credit, whether the payment card number is correct, and/or whether the expiration date associated with the payment card is correct. The issuer 424 then sends 1118 an authorization response message back to the payment network server system 302. The authorization response message includes an indication of whether the transaction was approved or denied. For example, in the exemplary implementation, if the transaction is denied, the issuer transmits 1014 (shown in FIG. 10) an authorization response message to the payment network server system 302 that includes a denial indicator.

At step 1120, the payment network server system 302 receives, from the issuer 424, the authorization response message in response to the authorization request message and queries database 308 to determine whether database 308 contains an indicator that merchant 436 has an outdate expiration date for the payment card. If database 308 contains an indicator that merchant 436 has an outdated expiration date for the payment card, payment network server 302 includes 1122 the later expiration (stored in database 308) in the authorization response message. At step 1124, the payment network server system 302 transmits the authorization response message to the acquirer 422. The acquirer 422 then transmits 1126 the authorization response message to the merchant 436. In alternative embodiments, rather than including the later expiration date in the authorization response message, payment network server 302 will provide the later payment card expiration date to acquirer 422 and/or merchant 436 through another delivery method, for example email, short message service (SMS), fax, telephonic voice message, mail, courier, and/or a secure website for which acquirer 422 and/or merchant 436 are provided authentication credentials. If the later payment card expiration date is delivered only to the acquirer 422 by payment network server system 302, acquirer 422 may present the later expiration date to the merchant proactively, or upon request by the merchant. In other embodiments, rather than providing the later expiration date to merchant 436 in any of the ways discussed above, payment network server 302 instead includes an indicator in the authorization response message indicating that merchant 436 should contact the cardholder to obtain the later payment card expiration date.

In one aspect, a method for processing a card-not-present account-on-file transaction is provided. The transaction is made by a cardholder using payment card information stored by a merchant. The method is performed using a computer device coupled to a database. The payment card information includes a payment card account identifier. The method includes receiving an authorization request message for the transaction, the authorization request message received at the computer device from an acquirer associated with the merchant. The method further includes receiving an authorization response message, the authorization response message received at the computer device from an issuer, the authorization response including a denial indicator indicating that the transaction has been denied. The method further includes querying the database coupled to the computer device to determine whether the database includes updated payment card information associated with the payment card account identifier associated with the transaction. The method further includes transmitting the updated payment card information associated with the payment card account identifier associated with the transaction to the acquirer for the acquirer to communicate to the merchant.

The method may be modified such that receiving an authorization request message comprises identifying, by the computer device, the authorization request message as relating to a card-not-present account-on-file transaction.

The method may further include storing, in the database, the authorization response message and denial indicator.

The method may be further modified such that receiving an authorization response message further comprises receiving an authorization response message including a denial indicator indicating that a card number associated with the authorization request is incorrect.

The method may be further modified such that receiving an authorization response message further comprises receiving an authorization response message including a denial indicator indicating that a card expiration date associated with the authorization request is incorrect.

The method may be further modified such that querying the database to determine whether the database includes updated payment card information includes determining whether an updated payment card number is stored in the database associated with the payment card account identifier associated with the transaction.

The method may be further modified such that querying the database to determine whether the database includes updated payment card information includes determining whether an updated expiration date is stored in the database associated with the payment card account identifier associated with the transaction.

The method may be further modified such that querying the database to determine whether the database includes updated payment card information includes determining whether an account cancellation flag is stored in the database associated with the payment card account identifier associated with the transaction.

The method may further be modified such that transmitting the updated payment card information is performed upon receiving a request from the acquirer for information regarding denied payment transactions.

The method may further be modified such that receiving the request from the acquirer for information regarding denied transactions comprises authenticating the acquirer by the computer device and transmitting the updated payment card information to the authenticated acquirer.

In another aspect, a network-based system for processing a card-not-present account-on-file transaction is provided. The transaction is made by a cardholder using payment card information stored by a merchant. The payment card information includes a payment card account identifier. The system includes a payment network, a payment database for storing updated information for the payment card, and a payment network server. The payment network communicatively couples the payment database with the payment network server. The payment network server is configured to receive a first authorization request message for the transaction, the first authorization request received from an acquirer computer. The payment network server is further configured to receive an authorization response message, the authorization response message received from an issuer, the authorization response including a denial indicator indicating that the transaction has been denied. The payment network server is further configured to query the payment database to determine whether the payment database includes updated payment card information associated with the payment card account identifier associated with the transaction. The payment network server is further configured to transmit the updated payment card information associated with the payment card account identifier associated with the transaction to the acquirer computer for the acquirer computer to communicate to the merchant computer.

The payment network server may be further configured to identify the authorization request message as relating to a card-not-present account-on-file transaction.

The payment network server may be further configured to store, in the payment database, the authorization response and denial indicator.

The payment network server may be further configured to query said payment database to determine whether said payment database includes at least one of an updated payment card number associated with the payment card account identifier associated with the transaction; an updated expiration date associated with the payment card account identifier associated with the transaction; and an account cancelation flag associated with the payment card account identifier associated with the transaction.

The payment network server may be further configured to identify whether the denial indicator indicates that a card number associated with the authorization request is incorrect or that an expiration date associated with the authorization request is incorrect.

The payment network server may be further configured to transmit the updated payment card information to the acquirer computer upon authenticating the acquirer computer to said payment network server.

In a further aspect, a computer coupled to a database for processing a card-not-present account-on-file transaction is provided. The transaction is made using payment card information stored by a merchant. The payment card information includes a payment card account identifier. The computer is programmed to receive an authorization request message for the transaction, the authorization request message received from an acquirer associated with the merchant. The computer is further programmed to receive an authorization response message, the authorization response message received from an issuer, the authorization response including a denial indicator indicating that the transaction has been denied. The computer is further programmed to query the database to determine whether the database includes updated payment card information for a payment card account identifier associated with the transaction. The computer is further programmed to transmit the updated payment card information associated with the payment card account identifier associated with the transaction to the acquirer for the acquirer to communicate to the merchant.

The computer may be further programmed to identify the authorization request message as relating to a card-not-present account-on-file transaction based on a card-not-present account-on-file flag in the authorization request message.

The computer may be further programmed to store in the database the authorization response and denial indicator.

The computer may be further programmed to query the database to determine whether the database includes at least one of an updated payment card number associated with the payment card account identifier associated with the transaction; an updated expiration date associated with the payment card account identifier associated with the transaction; and an account cancelation flag associated with the payment card account identifier associated with the transaction.

The computer may be further programmed to identify whether the denial indicator indicates that a card number associated with the authorization request is incorrect or that an expiration date associated with the authorization request is incorrect.

In another aspect, a non-transitory computer readable storage medium storing computer-executable instructions thereon for processing a card-not-present account-on-file transaction is provided. The transaction is made by a cardholder using payment card information stored by a merchant. The payment card information includes a payment card account identifier. When executed by a computer coupled to a database, the computer-executable instructions cause the computer to receive an authorization request message for the transaction, the authorization request message received from an acquirer associated with the merchant. The computer-executable instructions further cause the computer to receive an authorization response message, the authorization response message received from an issuer, the authorization response including a denial indicator indicating that the transaction has been denied. The computer-executable instructions further cause the computer to query the database to determine whether the database includes updated payment card information for a payment card account identifier associated with the transaction. The computer-executable instructions further cause the computer to transmit the updated payment card information associated with the payment card account identifier associated with the transaction to the acquirer for the acquirer to communicate to the merchant.

The computer-executable instructions may further cause the computer to store in the database the authorization response and denial indicator.

The computer-executable instructions may further cause the computer to query the database to determine whether the database includes at least one of an updated payment card number associated with the payment card account identifier associated with the transaction; an updated expiration date associated with the payment card account identifier associated with the transaction; and an account cancelation flag associated with the payment card account identifier associated with the transaction.

The computer-executable instructions may further cause the computer to transmit the updated payment card information associated with the payment card account identifier associated with the transaction to the acquirer upon receiving a request from the acquirer for information regarding denied payment transactions.

In another aspect, a method for processing a card-not-present account-on-file transaction over a computer device coupled to a database is provided. The card-not-present account-on-file transaction has a first transaction date. The transaction is made by a cardholder using payment card information stored by a merchant. The payment card information includes a payment card number. The method includes receiving a first authorization request message for the transaction, the first authorization request message received at the computer device from an acquirer associated with the merchant. The method further includes determining that the first authorization request message is associated with a card-not-present account-on-file transaction based on a first flag present in the first authorization request message. The method further includes identifying a first expiration date included in the authorization request message for the payment card number used for the transaction. The method further includes querying the database to determine if a second expiration date associated with the payment card number is stored therein, the second expiration date being later than the first expiration date. The method further includes modifying the authorization request message at the computer device by replacing the first expiration date with the second expiration date. The method further includes transmitting the authorization request message to an issuer associated with the payment card.

The method may further include determining that the first expiration date is earlier than or equal to the first transaction date.

The method may further include transmitting the second expiration date to at least one of the merchant and the acquirer.

The method may further include: receiving an authorization response message from the issuer; modifying the authorization response message to include the second expiration date or an indicator that the merchant should contact the cardholder for the second expiration date; and transmitting the authorization response message to the acquirer.

The method may further be modified such that the transaction is a first transaction, the merchant is one of a first merchant and a second merchant, and the acquirer is one of a first acquirer and a second acquirer, wherein the method further comprises: receiving a second authorization request message for a second transaction having a second transaction date, the second authorization request message received at the computer device from the acquirer associated with the merchant; determining that the second authorization request message is associated with a card present transaction based on a second flag included in the second authorization request message; identifying a third expiration date for the payment card number, the third expiration date included in the second authorization request message; storing the third expiration date for the payment card number in the database.

The above method may be modified such that the second transaction occurs before the first transaction.

The above method may further include transmitting the second authorization request message to the issuer; receiving an authorization response message from the issuer; determining that the authorization response message includes an indication that the third expiration date is incorrect or outdated; and deleting the third expiration date from the database coupled to the payment network.

In another aspect, a network-based system for processing a card-not-present account-on-file transaction having a first transaction date is provided. The transaction is made by a cardholder using payment card information stored by a merchant. The payment card information includes a payment card number. The system includes a payment network, a payment database for storing information for the payment card, and a payment network server, wherein said payment network communicatively couples the payment database with the payment network server. The payment network server is configured to receive a first authorization request message for the transaction, the first authorization request message received from an acquirer associated with the merchant. The payment network server is further configured to determine that the first authorization request message is associated with a card-not-present account-on-file transaction based on a first flag present in the first authorization request message. The payment network server is further configured to identify a first expiration date included in the authorization request message for the payment card number used for the transaction. The payment network server is further configured to query the payment database to determine if a second expiration date associated with the payment card number is stored therein, the second expiration date being later than the first expiration date. The payment network server is further configured to modify the authorization request message by replacing the first expiration date with the second expiration date. The payment network server is further configured to transmit the authorization request message to an issuer associated with the payment card.

The system may be modified such that said payment network server is further configured to determine that the first expiration date is earlier or equal to the first transaction date.

The system may be modified such that said payment network server is further configured to transmit the second expiration date to at least one of the merchant and the acquirer.

The system may be modified such that said payment network server is further configured to: receive an authorization response message from the issuer; modify the authorization response message to include the second expiration date or an indicator that the merchant should contact the cardholder for the second expiration date; and transmit the authorization response message to the acquirer.

The system may be modified such that the transaction is a first transaction, the merchant is one of a first merchant and a second merchant, the acquirer is one of a first acquirer and a second acquirer, and the payment network server is further configured to: receive a second authorization request message for a second transaction having a second transaction date, the second authorization request message received from the acquirer associated with the merchant; determine that the second authorization request message is associated with a card present transaction based on a second flag included in the second authorization request message; identify a third expiration date for the payment card number, the third expiration date included in the second authorization request message; store the third expiration date for the payment card number in said payment database.

The above system may be modified such that the second transaction occurs before the first transaction.

The system may further be modified such that the payment network server is further configured to: transmit the second authorization request message to the issuer; receive an authorization response message from the issuer; determine that the authorization response message includes an indication that the third expiration date is incorrect or outdated; and delete the third expiration date from said payment database.

In a further aspect, a computer coupled to a database for processing a card-not-present account-on-file transaction having a first transaction date is provided. The transaction is made by a cardholder using payment card information stored by a merchant. The payment card information includes a payment card number. The computer is programmed to receive a first authorization request message for the transaction, the first authorization request message received from an acquirer associated with the merchant. The computer is further programmed to determine that the first authorization request message is associated with a card-not-present account-on-file transaction based on a first flag present in the first authorization request message. The computer is further programmed to identify a first expiration date included in the authorization request message for the payment card number used for the transaction. The computer is further programmed to query the database to determine if a second expiration date associated with the payment card number is stored therein, the second expiration date being later than the first expiration date. The computer is further programmed to modify the authorization request message by replacing the first expiration date with the second expiration date. The computer is further programmed to transmit the authorization request message to an issuer associated with the payment card.

The computer may be further programmed to determine that the first expiration date is earlier or equal to the first transaction date.

The computer may be further programmed to transmit the second expiration date to at least one of the merchant and the acquirer.

The computer may be further programmed to: receive an authorization response message from the issuer, modify the authorization response message to include the second expiration date or an indicator that the merchant should contact the cardholder for the second expiration date; and transmit the authorization response message to the acquirer.

The computer may be further programmed to perform the process discussed above, wherein the transaction is a first transaction, the merchant is one of a first merchant and a second merchant, and the acquirer is one of a first acquirer and a second acquirer, wherein said computer is further programmed to: receive a second authorization request message for a second transaction having a second transaction date, the second authorization request message received from the acquirer associated with the merchant; determine that the second authorization request message is associated with a card present transaction based on a second flag included in the second authorization request message; identify a third expiration date for the payment card number, the third expiration date included in the second authorization request message; store the third expiration date for the payment card number in the database.

The computer may be further programmed to perform the process described above, wherein the second transaction occurs before the first transaction.

The computer may be further programmed to: transmit the second authorization request message to the issuer; receive an authorization response message from the issuer; determine that the authorization response message includes an indication that the third expiration date is incorrect or outdated; and delete the third expiration date from the database.

In yet another aspect, a non-transitory computer readable storage medium storing computer-executable instructions thereon for processing a card-not-present account-on-file transaction having a first transaction date is provided. The transaction is made by a cardholder using payment card information stored by a merchant. The payment card information includes a payment card number. When executed by a computer coupled to a database, the computer-executable instructions cause the computer to receive a first authorization request message for the transaction, the first authorization request message received from an acquirer associated with the merchant. The computer-executable instructions further cause the computer to determine that the first authorization request message is associated with a card-not-present account-on-file transaction based on a first flag present in the first authorization request message. The computer-executable instructions further cause the computer to identify a first expiration date included in the authorization request message for the payment card number used for the transaction. The computer-executable instructions further cause the computer to query the database to determine if a second expiration date associated with the payment card number is stored therein, the second expiration date being later than the first expiration date. The computer-executable instructions further cause the computer to modify the authorization request message by replacing the first expiration date with the second expiration date. The computer-executable instructions further cause the computer to transmit the authorization request message to an issuer associated with the payment card.

The computer-executable instructions may further cause the computer to determine that the first expiration date is earlier or equal to the first transaction date.

The computer-executable instructions may further cause the computer to transmit the second expiration date to at least one of the merchant and the acquirer.

The computer-executable instructions may further cause the computer to carry out the process described above, wherein the merchant is one of a first merchant and a second merchant, the acquirer is one of a first acquirer and a second acquirer, and wherein said computer-executable instructions further cause the computer to: receive a second authorization request message for a second transaction having a second transaction date, the second authorization request message received from the acquirer associated with the merchant; determine that the second authorization request message is associated with a card present transaction based on a second flag included in the second authorization request message; identify a third expiration date for the payment card number, the third expiration date included in the second authorization request message; store the third expiration date for the payment card number in the database.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for processing a card-not-present account-on-file transaction over a computer device coupled to a database, the transaction made by a cardholder using payment card information stored by a merchant, the payment card information including a payment card account identifier, an expiration date associated with the payment card account identifier, and a payment card number associated with the payment card account identifier, said method comprising:
receiving a first authorization request message for the transaction, the first authorization request message received at the computer device from an acquirer associated with the merchant;
determining that the first authorization request message is associated with a card-not-present account-on-file transaction based on a first flag present in the first authorization request message;
querying the database to determine whether updated payment card information is stored therein, the updated payment card information including at least one of an updated expiration date associated with the payment card account identifier and an updated payment card number associated with the payment card account identifier;
transmitting a second authorization request message for the transaction to an issuer associated with the payment card account identifier, the second authorization request message including the updated payment card information.

2. A method in accordance with claim 1, further comprising:
receiving an authorization response message for the transaction, the authorization response message received at the computer device from the issuer; and
transmitting the authorization response message to the acquirer.

3. A method in accordance with claim 1, further comprising:
identifying a denial indicator in the authorization response message;
determining whether the denial indicator pertains to an incorrect payment card number, an incorrect expiration date, or a canceled account; and
storing the authorization response message and denial indicator in the database.

4. A method in accordance with claim 1, further comprising:
transmitting the updated payment card information associated with the payment card account identifier to at least one of the acquirer and the merchant.

5. A method in accordance with claim 1, further comprising:
creating the second authorization request message at the computer by replacing at least one of the expiration date associated with the payment card account identifier and the payment card number associated with the payment card account identifier with the updated payment card information.

6. A method in accordance with claim 1, further comprising:
receiving the second authorization request message from the acquirer, the second authorization request message received at the computer device.

7. A method in accordance with claim 1, further comprising:
modifying the authorization response message to include the updated payment card information or an indicator that the merchant should contact the cardholder for the updated payment card information; and
transmitting the authorization response message to the acquirer.

8. A method in accordance with claim 1, further comprising:
receiving a third authorization request message for a second transaction, the third authorization request message received at the computer device, the third authorization request message including the updated payment card information associated with the payment card account identifier;
determining that the third authorization request message is associated with a card-present transaction based on a second flag included in the third authorization request message;
storing the updated payment card information associated with the payment card account identifier in the database.

9. A network-based system for processing a card-not-present account-on-file transaction made by a cardholder using payment card information stored by a merchant, the payment card information including a payment card account identifier, an expiration date associated with the payment card account identifier, and a payment card number associated with the payment card account identifier, said system comprising:
a payment network;
a payment database for storing information for the payment card; and
a payment network server, wherein said payment network communicatively couples said payment database with said payment network server, and wherein said payment network server is configured to:
receive a first authorization request message for the transaction, the first authorization request message received from an acquirer associated with the merchant;
determine that the first authorization request message is associated with a card-not-present account-on-file transaction based on a first flag present in the first authorization request message;
query the payment network database to determine whether updated payment card information is stored therein, the updated payment card information including at least one of an updated expiration date associated with the payment card account identifier and an updated payment card number associated with the payment card account identifier;
transmit a second authorization request message for the transaction to an issuer associated with the payment card account identifier, the second authorization request message including the updated payment card information.

10. A system in accordance with claim 9, wherein said payment network server is further configured to:
receive an authorization response message for the transaction, the authorization response message received from the issuer; and
transmit the authorization response message to the acquirer.

11. A system in accordance with claim 9, wherein said payment network server is further configured to:
identify a denial indicator in the authorization response message;
determine whether the denial indicator pertains to an incorrect payment card number, an incorrect expiration date, or a canceled account; and
store the authorization response message and denial indicator in the payment network database.

12. A system in accordance with claim 9, wherein said payment network server is further configured to:
transmit the updated payment card information associated with the payment card account identifier to at least one of the acquirer and the merchant.

13. A system in accordance with claim 9, wherein said payment network server is further configured to:
create the second authorization request message at the computer by replacing at least one of the expiration date associated with the payment card account identifier and the payment card number associated with the payment card account identifier with the updated payment card information.

14. A system in accordance with claim 9, wherein said payment network server is further configured to:
receive the second authorization request message from the acquirer.

15. A system in accordance with claim 9, wherein the payment network server is further configured to:
modify the authorization response message to include the updated payment card information or an indicator that the merchant should contact the cardholder for the updated payment card information; and
transmit the authorization response message to the acquirer.

16. A system in accordance with claim 9, wherein the payment network server is further configured to:
receive a third authorization request message for a second transaction, the third authorization request message including the updated payment card information associated with the payment card account identifier;
determine that the third authorization request message is associated with a card-present transaction based on a second flag included in the third authorization request message;
store the updated payment card information associated with the payment card account identifier in the payment network database.

17. A computer coupled to a database for processing a card-not-present account-on-file transaction made by a cardholder using payment card information stored by a merchant, the payment card information including a payment card number, said computer programmed to:
receive a first authorization request message for the transaction, the first authorization request message received from an acquirer associated with the merchant;
determine that the first authorization request message is associated with a card-not-present account-on-file transaction based on a first flag present in the first authorization request message;
query the database to determine whether updated payment card information is stored therein, the updated payment card information including at least one of an updated expiration date associated with the payment card account identifier and an updated payment card number associated with the payment card account identifier;
transmit a second authorization request message for the transaction to an issuer associated with the payment card account identifier, the second authorization request message including the updated payment card information.

18. A computer in accordance with claim 17, wherein said computer is further programmed to:
receive an authorization response message for the transaction, the authorization response message received from the issuer; and
transmit the authorization response message to the acquirer.

19. A computer in accordance with claim 17, wherein said computer is further programmed to:
identify a denial indicator in the authorization response message;
determine whether the denial indicator pertains to an incorrect payment card number, an incorrect expiration date, or a canceled account; and
store the authorization response message and denial indicator in the database.

20. A computer in accordance with claim 17, wherein said computer is further programmed to:
transmit the updated payment card information associated with the payment card account identifier to at least one of the acquirer and the merchant.

21. A computer in accordance with claim 17, wherein said computer is further programmed to:
create the second authorization request message by replacing at least one of the expiration date associated with the payment card account identifier and the payment card number associated with the payment card account identifier with the updated payment card information.

22. A computer in accordance with claim 17, wherein said computer is further programmed to:
receive the second authorization request message from the acquirer.

23. A computer in accordance with claim 17, wherein said computer is further programmed to:
modify the authorization response message to include the updated payment card information or an indicator that the merchant should contact the cardholder for the updated payment card information; and
transmit the authorization response message to the acquirer.

24. A computer in accordance with claim 17, wherein said computer is further programmed to:
receive a third authorization request message for a second transaction, the second authorization request message received at the computer device, the third authorization request message including the updated payment card information associated with the payment card account identifier;
determine that the third authorization request message is associated with a card-present transaction based on a second flag included in the third authorization request message;
store the updated payment card information associated with the payment card account identifier in the database.

25. A non-transitory computer readable storage medium storing computer-executable instructions thereon for processing a card-not-present account-on-file transaction made by a cardholder using payment card information stored by a merchant, the payment card information including a payment card account identifier, an expiration date associated with the payment card account identifier, and a payment card number associated with the payment card account identifier, wherein when executed by a computer coupled to a database, causes the computer to:
receive a first authorization request message for the transaction, the first authorization request message received from an acquirer associated with the merchant;
determine that the first authorization request message is associated with a card-not-present account-on-file transaction based on a first flag present in the first authorization request message;
query the database to determine whether updated payment card information is stored therein, the updated payment card information including at least one of an updated expiration date associated with the payment card account identifier and an updated payment card number associated with the payment card account identifier;
transmit a second authorization request message for the transaction to an issuer associated with the payment card account identifier, the second authorization request message including the updated payment card information.

26. The non-transitory computer readable storage medium in accordance with claim 25, wherein said computer-executable instructions further cause the computer to:
receive an authorization response message for the transaction, the authorization response message received from the issuer; and
transmit the authorization response message to the acquirer.

27. The non-transitory computer readable storage medium in accordance with claim 25, wherein said computer-executable instructions further cause the computer to:
identify a denial indicator in the authorization response message;
determine whether the denial indicator pertains to an incorrect payment card number, an incorrect expiration date, or a canceled account; and
store the authorization response message and denial indicator in the database.

28. The non-transitory computer readable storage medium in accordance with claim 25, wherein said computer-executable instructions further cause the computer to:
transmit the updated payment card information associated with the payment card account identifier to at least one of the acquirer and the merchant.

29. The non-transitory computer readable storage medium in accordance with claim 25, wherein said computer-executable instructions further cause the computer to:
create the second authorization request message by replacing at least one of the expiration date associated with the payment card account identifier and the payment card number associated with the payment card account identifier with the updated payment card information.

30. The non-transitory computer readable storage medium in accordance with claim 25, wherein said computer-executable instructions further cause the computer to:
receive the second authorization request message from the acquirer.

31. The non-transitory computer readable storage medium in accordance with claim 25, wherein said computer-executable instructions further cause the computer to:
modify the authorization response message to include the updated payment card information or an indicator that the merchant should contact the cardholder for the updated payment card information; and
transmit the authorization response message to the acquirer.

32. The non-transitory computer readable storage medium in accordance with claim 25, wherein said computer-executable instructions further cause the computer to:
receive a third authorization request message for a second transaction, the third authorization request message including the updated payment card information associated with the payment card account identifier;
determine that the third authorization request message is associated with a card-present transaction based on a second flag included in the third authorization request message;
store the updated payment card information associated with the payment card account identifier in the database.
